(19) United States
(12) Patent Application Publication
(10) Pub. No.: US 2026/0264577 A1
(43) Pub. Date: Sep. 10, 2026

(54) ACTUATION ASSEMBLY FOR LONGITUDINAL VEHICLE SEAT ADJUSTMENT MECHANISM

(71) Applicant: Brose Fahrzeugteile SE & Co. Kommanditgesellschaft, Coburg, Coburg (DE)

(72) Inventors: Sean Sabo, West Bloomfield, MI (US); Matthew Sinke, Royal Oak, MI (US)

(21) Appl. No.: 19/074,058

(22) Filed: Mar. 7, 2025

(51) Int. Cl. B60N 2/08

(52) U.S. Cl. CPC B60N 2/0887

(57) ABSTRACT

Actuation sub-assemblies and product line for vehicle seats. The actuation assembly includes, in one example, a modular base with a cross-tube including opposing ends that are configured to mechanically interface with the longitudinal vehicle seat adjustment mechanism. The modular base further includes one or more mounting bodies formed on or coupled to the cross-tube. In the actuation assembly the one or more mounting bodies include multiple recesses. Further, in the actuation assembly, each of the multiple recesses are configured to receive any one of multiple cross-compatible mounting arms that are included in multiple types of grab handles.

### FIELD

The present description relates generally to an actuation assembly for an adjustment mechanism that functions to manually alter a longitudinal position of a vehicle seat.

### BACKGROUND AND SUMMARY

Vehicles have made use of manual track actuators to enable vehicle occupants to alter the longitudinal position of vehicle seats according to their preferences. Specifically, certain vehicle seat assemblies utilize the manual track actuators that function to release and lock seat slide rails or other longitudinal seat adjustment mechanisms.

Certain manual track actuators have been at least partially constructed out of welded metal tubing. Vehicles however may have a wide variety of packaging demands for the manual track actuators. Therefore, the manual track actuators have many variants across different vehicle platforms. The use of welded manual track actuators demands distinct actuator constructions, thereby increasing manufacturing complexity and duration. The inventors have recognized a need to increase manual track actuator compatibility and reduce manufacturing duration and complexity.

Facing the aforementioned challenges, the inventors developed an actuation assembly for a longitudinal vehicle seat adjustment mechanism that at least partially addresses the challenges. The actuation assembly includes, in one example, a modular base that has a cross-tube with opposing ends that are configured to mechanically interface with the longitudinal vehicle seat adjustment mechanism. The modular base further includes one or more mounting bodies that are formed on or coupled to the cross-tube. In the actuation assembly, the one or more mounting bodies include multiple recesses and each of the multiple recesses are configured to receive any one of multiple cross-compatible mounting arms that are included in multiple types of grab handles. In this way, the adaptability of the actuation assembly is increased, thereby enabling the assembly to be used in a wide variety of vehicle seats with different packaging demands. Further, the manufacturing efficiency of the actuation assemblies that are tailored for these different packaging demands is increased when compared to previous manufacturing techniques for constructing differently sized and/or contoured actuator mechanisms that involve complex manufacturing techniques such welding multiple tubes, for instance.

In one example, attachment ends of the cross-compatible mounting arms may be identical in size and shape to enable the efficient reconfiguration of the actuation assembly. Customer appeal is even further increased as a result.

Further in one example, the cross-tube may be an overmolded cross-tube that includes an inner metal tube and an outer plastic layer. The overmolded cross-tube enables the durability of the assembly to be increased and allows the mounting bodies to be efficiently manufactured.

Even further in one example, the one or more mounting bodies may each include an actuation lever that is configured to actuate the longitudinal vehicle seat adjustment mechanism in response to rotation of the modular base about a rotational axis of the overmolded cross-tube. In this way, the actuation lever is space efficiently integrated into the mounting body.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is an exploded view of an example of a system capable of different actuation assembly configurations for a longitudinal vehicle seat adjustment mechanism.

FIGS. 2-5 are assembled views of the different configurations of the actuation assembly, depicted in FIG. 1, that use a modular base with cross-compatibility.

FIG. 6 is a detailed view of a portion of an overmolded cross-tube that is included in the modular base of the actuation assembly depicted in FIG. 1.

FIG. 7 is a detailed cross-sectional view of the overmolded cross-tube depicted in FIG. 6.

FIG. 8 is an example of a product line of the actuation assemblies depicted in FIGS. 2-5.

### DETAILED DESCRIPTION

A modular actuation assembly and actuation assembly product line are described herein that exhibit an adaptable construction for use in a wide variety of vehicle seat variants with different packaging demands. To achieve the modular construction, the actuation assembly includes a base with a cross-tube, such as an overmolded cross-tube, that has one or more mounting bodies. The mounting bodies are incorporated into or coupled to the cross-tube for attaching different types of grab handles. Specifically, the grab handle mounting interfaces are profiled to receive mounting arms that are included in multiple types of grab handles but have a similar size and shape to enable for attachment to the base. Therefore, the modular base is able to be efficiently constructed and connected to different grab handles to suit the packaging demands of different vehicle seats. Customer appeal is increased as a result.

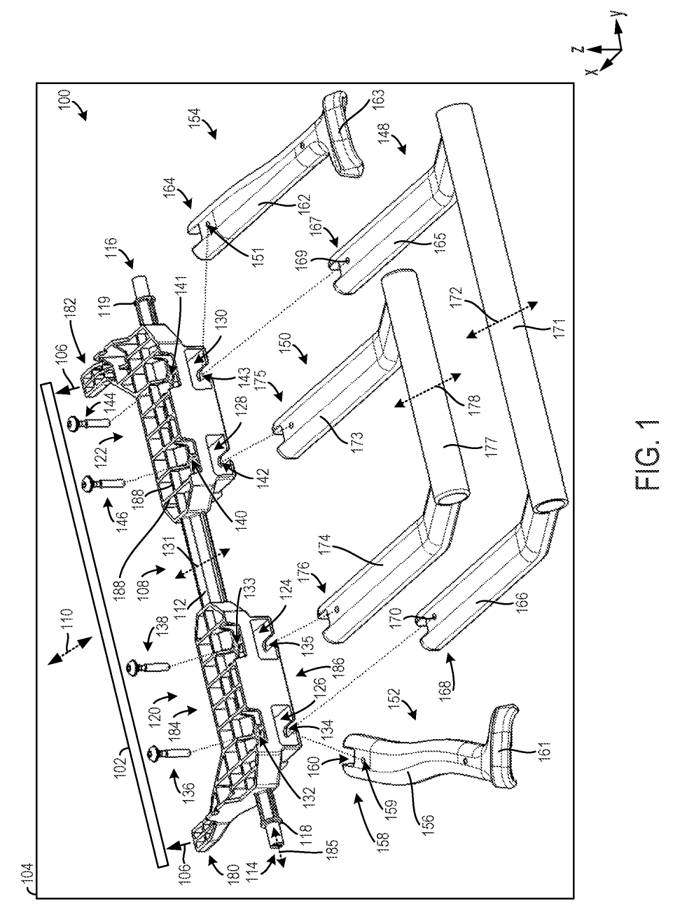

FIG. 1 shows a disassembled configuration of an actuation assembly system 100 for a longitudinal vehicle seat adjustment mechanism 102 in a vehicle seat 104. As elaborated upon herein, the actuation assembly system 100 may be used to form different actuation assemblies that are able to meet different packaging demands of a variety of vehicle seats. As such, when the actuation assemblies are constructed, they are designed to manually actuate the longitudinal vehicle seat adjustment mechanism 102. Arrows 106 generally indicate the mechanical interaction between a modular base 108 in the actuation assembly system 100 and the longitudinal vehicle seat adjustment mechanism 102 which is expanded upon herein.

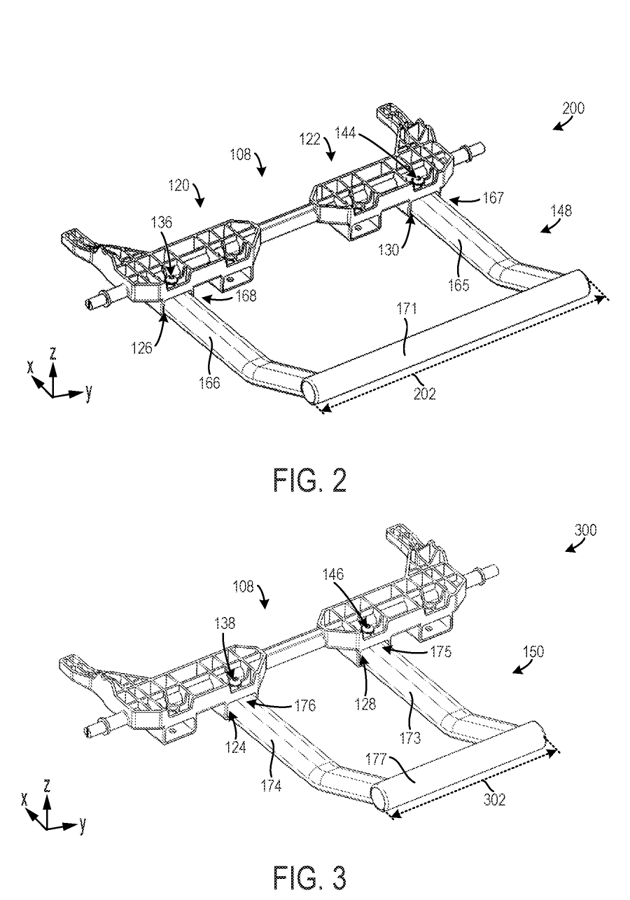

The longitudinal vehicle seat adjustment mechanism 102 and the vehicle seat 104 are both schematically depicted in the illustrated example. However, it will be understood that the vehicle seat has more structural complexity, in practice. For instance, the longitudinal vehicle seat adjustment mechanism 102 may include a comb lock, sliding rails, and/or other components that enable the mechanism to alter the position of the vehicle seat 104 along a longitudinal axis 110. The longitudinal axis is parallel to an x-axis in a coordinate axis system that is provided in FIG. 1 as well as FIGS. 2-8, for reference. The z-axis may be a vertical axis (e.g., parallel to a gravitational axis), the y-axis may be a lateral axis (e.g., horizontal axis), and/or the x-axis may be a longitudinal axis, in one example. However, the axes may have other orientations, in other examples. The components in FIGS. 1-8 are drawn approximately to scale, aside from the schematically depicted components. However, other relative component dimensions may be used, in other embodiments.

The longitudinal vehicle seat adjustment mechanism 102 functions to alter a longitudinal position of the vehicle seat 104. To elaborate, the longitudinal vehicle seat adjustment mechanism 102 may be actuated via an actuation assembly (e.g., specifically the modular base 108 and/or another suitable component in the actuation assembly) to selectively place the longitudinal vehicle seat adjustment mechanism 102 in an unlocked configuration where the operator can slide the seat along the longitudinal axis according to their preferences. Release of the actuation assembly conversely may return the longitudinal vehicle seat adjustment mechanism 102 to a locked configuration where the longitudinal positon of the seat is fixed. However, alternate vehicle seat adjustment mechanism kinematics are possible.

The actuation assembly system 100 is configurable in multiple variants. Specifically, the actuation assembly system 100 includes the modular base 108 that is used in all of the different variants. In this way, manufacturing of the base across different assembly designs can be simplified.

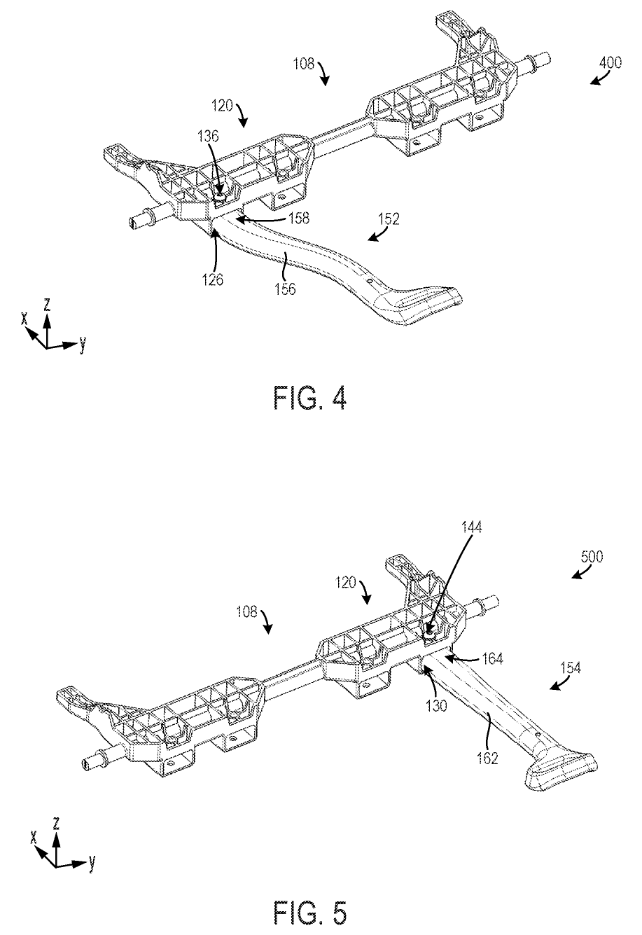

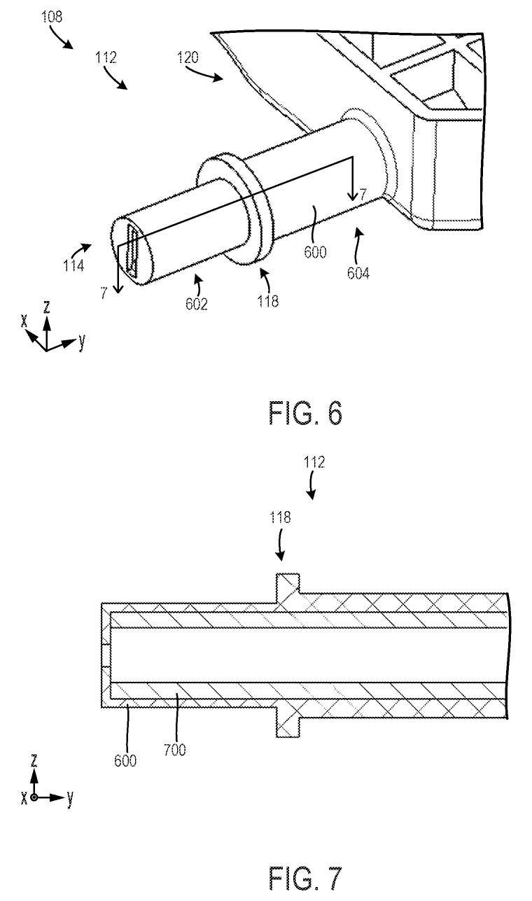

The modular base 108 includes a cross-tube 112. The cross-tube 112 may be overmolded with a metal inner tube and an outer plastic layer, as discussed in greater detail herein with regard to FIGS. 6-7. In the illustrated example, the cross-tube 112 included opposing ends 114 and 116. When installed, the opposing ends 114 and 116 of the cross-tube 112 are configured to mechanically interface (e.g., rotationally interface) with the longitudinal vehicle seat adjustment mechanism 102. For instance, the opposing ends 114 and 116 may be mated with openings in the longitudinal vehicle seat adjustment mechanism 102. However, other suitable types of mechanical interfaces between the cross-tube and the seat adjustment mechanism may be used in other examples.

In the illustrated example, the cross-tube 112 includes flanges 118 and 119 that are positioned near the ends 114 and 116, respectively, and therefore are positioned outboard of mounting bodies 120 and 122, discussed in greater detail herein. The flanges 118 and 119 may allow the modular base 108 to be efficiently installed in longitudinal vehicle seat adjustment mechanism 102 at an appropriate lateral position.

The modular base 108 includes two mounting bodies 120 and 122 in the illustrated example. However, the modular base 108 may include a fewer or greater number of mounting bodies in alternate examples. For instance, the modular base 108 may include a single mounting body in an alternate example. The mounting bodies 120 and 122 may be integrally formed with the plastic layer of the cross-tube, in one example. However, in another example, the mounting bodies 120 and 122 may be removably coupled to the cross-tube 112.

To enable efficient grab handle attachment, each of the mounting bodies 120 and 122 include multiple recesses, in the illustrated example. Specifically, in the illustrated example, the mounting body 120 includes an inboard recess 124 and an outboard recess 126. Similarly, the mounting body 122 includes an inboard recess 128 and an outboard recess 130, in the illustrated example. However, the mounting bodies may include an alternate number of mounting arm recesses in alternate embodiments. For instance, each mounting body may include a single recess, in one example, or three or more recesses, in another example. As discussed herein, inboard and outboard refer to relative component positions in relation to a centerline (on a lateral axis) of the component. A centerline 131 (in relation to lateral axis) of the modular base 108 is illustrated in FIG. 1 for reference.

The recesses 124 and 126 may be conceptually grouped into a set of recesses. Similarly, the recesses 128 and 130 may also be conceptually grouped into another set of recesses. Further, the recesses 124, 126, 128, and 130 are positioned below the cross-tube 112 with regard to the z-axis in the illustrated embodiment. Positioning the recesses below the cross-bar allows the ends of the mounting arms to space efficiently extend under the cross-bar. However, the recesses may be positioned above the cross-bar in alternate embodiments.

In the illustrated example, each of the recesses 124, 126, 128, and 130 have a polygonal cross-sectional profile in a plane that is parallel to an z-x plane with regard to the coordinate axis system, that is described in greater detail herein. Shaping the recesses with a polygonal profile allows grab handles to be quickly mounted to the modular base 108 in an appropriate orientation. To elaborate, each of the recesses 124, 126, 128, and 130 has a rectangular profile in a plane that is parallel to the z-x plane in the illustrated example. However, other polygonal cross sectional profiles of the recesses are possible such as a square profile, a hexagonal profile, etc. Further, in alternate embodiments the recesses may have a circular cross-sectional profile or an elliptical cross-sectional profile, for instance. As expanded upon herein, the recesses receive mounting arms to form a mated interface in the actuation assemblies. As such, in this descriptive framework, the recesses and the mounting arms are formed as female and male components of the mated interface, respectively.

The mounting body 120 includes upper attachment device openings 132 and 133 and lower attachment device openings 134 and 135. To elaborate, in the illustrated example, an upper attachment device opening and a lower attachment device opening are provided for each of the recesses 124 and 126 such that attachment devices 136 and 138 (e.g., a bolt, a screw, a pin, and the like) are able to extend through the associated openings and removably attach mounting arms in grab handles that are explained in greater specificity herein. However, in alternate examples, only a portion of the recesses may have associated attachment device openings. The mounting body 122 similarly includes upper attachment device openings 140 and 141 as well as lower attachment device openings 142 and 143. Attachment devices 144 and 146 are again provided to removably attach the mounting arms to the mounting body 122.

Multiple grab handles 148, 150, 152, and 154 are depicted in FIG. 1 to illustrate the wide variety of assembly configurations that are possible. To elaborate, each of the grab handles 148, 150, 152, and 154 is designed to be coupled to the modular base 108 to form different actuation assemblies. Therefore, to form a single assembly, one of the grab handles may be selected to attach to the modular base, as discussed in greater detail herein with regard to FIGS. 2-5 and 8.

As illustrated in FIG. 1, the grab handle 152 includes a single mounting arm 156 that is configured (e.g., sized and profiled) to mate with any of the recesses 124, 126, 128 and 130, although specifically in the depicted example, the grab handle 152 is shown in pre-alignment with the outboard recess 126. An attachment end 158 of the mounting arm 156 is specifically sized and profiled to mate with the recess 126 or any of the other recesses in the modular base 108. The attachment end 158 include an attachment device opening 159 that is profiled to receive the attachment device when the base is assembled. The attachment end 158 further includes a notch 160 that allows for secure connection to the mounting body. However, the attachment end 158 and/or the other attachment ends described herein may have an alternate structure, in other examples. The attachment end 158 of the mounting arm 156 has a similar size and profile to the attachment ends of the other mounting arm attachment ends described herein. In this way, the ends of the mounting arms are cross-compatible. Therefore, the mounting arms may be referred to as cross-compatible mounting arms.

The grab handle 152 include a grip portion 161 that extends from the mounting arm 156. The grip portion 161 may be curved or otherwise formed for ergonomic interaction with a hand of an operator. The grab handle 152 is also laterally asymmetric in the illustrated example, to enable the grip portion 161 to be placed in a desired position. However, the grab handle 152 may laterally symmetric, in an alternate example.

The grab handle 154 also includes a single mounting arm 162 and a grip portion 163. However, the grab handle 154 has a lateral mirrored geometry in comparison to the grab handle 152. Additionally, the attachment end 164 of the grab handle 154 has an attachment device opening 151. The attachment ends 164 and 158 (and other attachment ends of the mounting arms) have a similar size and geometry to allow the ends to be mated with any of the recesses 124, 126, 128, and 130. In this way, the system’s adaptability is increased.

The grab handle 148 includes multiple mounting arms 165 and 166. Specifically, in the illustrated example, the mounting arms 165 and 166 are configured to mate with the outboard recesses 126 and 130 in the illustrated example. In particular, the mounting arms 165 and 166 include attachment ends 167 and 168 that are similarly sized and profiled in comparison to the other attachment ends described herein as previously discussed. The attachment ends 167 and 168 therefore again include attachment device openings 169 and 170.

A grab tube 171 extends between the mounting arms 165 and 166, in the illustrated example. Further, in the illustrated example, the grab handle 148 is laterally symmetric about an axis 172. Additionally, the mounting arms 165 and 166 curve upward (in relation the z-axis), in the illustrated example. However, other mounting arm profiles have been contemplated.

The grab handle 150 also includes multiple mounting arms 173 and 174. Specifically, in the illustrated example, the mounting arms 173 and 174 are configured to mate with the inboard recesses 124 and 128 in the illustrated example. In particular, the mounting arms 173 and 174 include attachment ends 175 and 176 that are similarly sized and profiled in comparison to the other attachment ends in the previously described grab handles.

A grab tube 177 extends between the mounting arms 173 and 174, in the illustrated example. Further, in the illustrated example, the grab handle 150 is laterally symmetric about an axis 178. The grab handle 150 has a smaller lateral width than the grab handle 148. However, the grab handles 148 and 150 are similarly profiled aside from the variance in lateral width. Redundant description of the overlapping features is omitted for concision.

The mounting bodies 120 and 122 include actuation levers 180 and 182, in the illustrated example. To expound, the actuation levers 180 and 182 are positioned on a rear longitudinal side 184 of the associated mounting body and the recesses are positioned on a front longitudinal side 186 of the associated mounting body. The actuation levers 180 and 182 are configured to actuate the longitudinal vehicle seat adjustment mechanism 102. In particular, the actuation levers 180 and 182 may be designed to actuate the longitudinal vehicle seat adjustment mechanism 102 in response to rotation of the modular base 108 about an axis of rotation 185. However, the actuator may be designed with alternate actuation kinematics.

The mounting bodies 120 and 122 have a mirrored lateral profile in the illustrated example. However, alternate mounting body profiles may be used in other examples. Reinforcing ribs 188 may also be provided in the mounting bodies 120 and 122. In particular, a portion of the reinforcing ribs may be laterally aligned and a portion of the reinforcing ribs may be longitudinally aligned. In this way, the structural integrity of the modular base is increased.

FIGS. 2-5 show different grab handle configurations that can be used in different actuation assembly constructions. It will be understood that the modular base 108 is shared across the different constructions. In this way, a modular base with an identical size and shape may be used for assemblies that are tailored to meet different seat packaging demands with regard to the grab handle configuration. Consequently, manufacturing duration and complexity is reduced.

FIG. 2 specifically shows an actuation assembly 200 with the modular base 108 and the grab handle 148 removably attached thereto. As previously discussed the grab handle 148 has the mounting arms 165 and 166 and the grab tube 171 extending between the arms. The ends 167 and 168of the mounting arms 165 and 166, respectively, are mated with the recesses 130 and 126, respectively. Further, as shown in FIG. 2, the attachment devices 136 and 144 have been mated with the attachment device openings in both the mounting bodies 120 and 122 as well as the mounting arms 166 and 165 to form a secure attachment interface between the modular base 108 and the grab handle 148.

FIG. 3 shows another actuation assembly 300 with the modular base 108 and the grab handle 150 attached thereto. As previously discussed the grab handle 150 includes the mounting arms 173 and 174 and the grab tube 177 that extends between the arms. The ends 175 and 176 of the mounting arms 173 and 174 are mated with recesses 128 and 124 in the mounting bodies 122 and 120, respectively. Further, the attachment devices 146 and 138 are removably coupled to the mounting bodies 122 and 120 and the grab handle mounting arms 173 and 174.

The grab handle 150 has a smaller lateral width 302 than the lateral width 202 of the grab handle 148 depicted in FIG. 2. In this way, the actuation assembly is capable of being adapted for different end-use packaging demands.

FIG. 4 shows an actuation assembly 400 with the modular base 108 and the grab handle 152 removably attached thereto. As previously discussed the grab handle has the single mounting arm 156. The end 158 of the mounting arm 156 is shown mated with the recess 126. Further, the attachment device 136 is removably attached to the mounting body 120 and the mounting arm 156. In this way, yet another actuation assembly configuration is achieved.

FIG. 5 shows another actuation assembly 500 with the modular base 108 and the grab handle 154 removably attached thereto. The grab handle 154 shown in FIG. 5 has a mirrored geometry with regard to the grab handle 152, shown in FIG. 4, as previously discussed. The end 164 of the mounting arm 162 is shown mated with the recess 130. Further, the attachment device 136 is removably attached to the mounting body 122 and the mounting arm 162.

FIG. 6 shows a detailed view of the end 114 of the cross-tube 112 in the modular base 108. The flange 118 is formed in the cross-tube 112, as previously discussed. Specifically, the flange 118 is formed in an overmolded plastic layer 600 of the cross-tube 112, in the illustrated example. The cross-tube 112 may have a smaller diameter section 602 outboard from the flange 118 to enable the modular base to attach to the longitudinal seat adjustment mechanism. However, the cross-tube may have alternate geometries in other embodiments. A portion of the mounting body 120 is also depicted in FIG. 6. Further, in the illustrated example, the cross-tube 112 includes a larger diameter section 604 that is positioned inboard of the flange 118. Cutting plane 7-7 depicts the location of the cross-sectional view of FIG. 7.

FIG. 7 shows the cross-tube 112 with an inner metal tube 700 and the overmolded plastic layer 600. Additionally, the flange 118 in the overmolded plastic layer 600 is again depicted. The flanges in the cross-tube 112 allow the tube to be efficiently installed in the longitudinal vehicle seat adjustment mechanism with a desired lateral position. However, the cross-tube may be profiled without the flanges in an alternate embodiment. The inner metal tube 700 may be constructed out of aluminum, steel, combinations thereof, and the like. Additionally, the smaller diameter section 602 of the cross-tube 112 is again illustrated. Using an overmolded cross-tube construction allows the chance of degradation to the inner metal tube to be reduced when compared to all-metal cross-tube constructions.

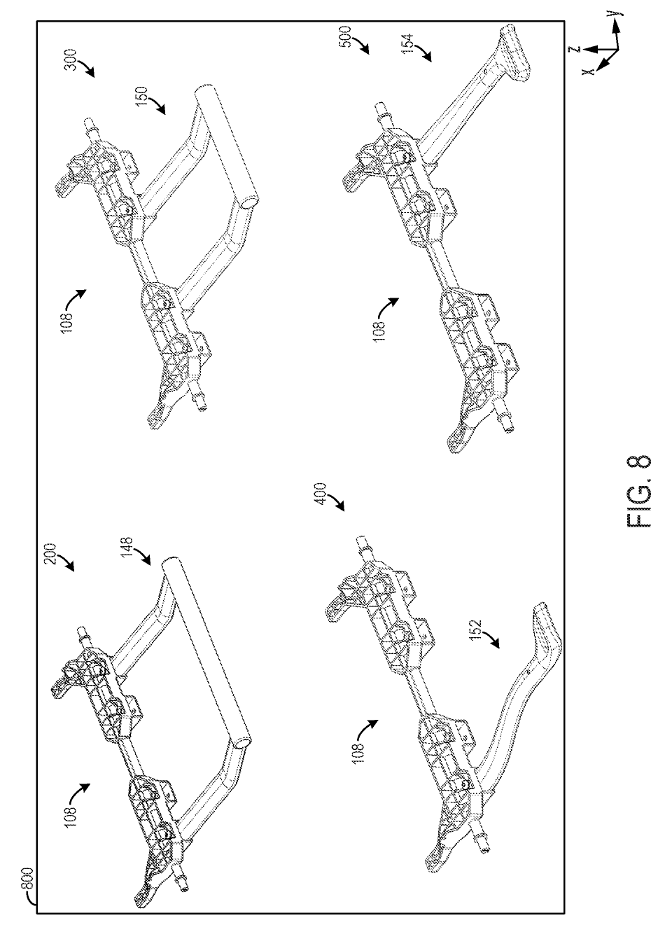

FIG. 8 shows a product line 800 with the previously described actuation assemblies 200, 300, 400, and 500. Each of the actuation assemblies 200, 300, 400, and 500 use the modular base 108 with differently shaped grab handles 148, 150, 152, and 154 removably attached thereto. Each of the assemblies may be coupled within a seat assembly of a vehicle. As such, four distinct vehicles may be formed, each with a distinct seat assembly, yet each using the same modular base 108. In this way, vehicles can be offered with different seats yet using a common base. The product line 800 is more efficient to manufacture due to the use of one type of modular base across the different actuation assemblies in comparison to other constructions for the actuation assemblies that use differently profiled bases for each assembly.

The vehicle seat actuation assemblies described herein achieve less complex manufacturing processes across the product line as well as meet the packaging demands of different vehicle platforms. Consequently, economic gains are able to be achieved in the manufacturing processes for the actuation assemblies.

FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. Further still, an element shown within another element or shown outside of another element may be referred as such, in one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example.

The invention will further be described in the following paragraphs. In one aspect, a vehicle seat actuation assembly for a longitudinal vehicle seat adjustment mechanism is provided that comprises: a modular base including: a cross-tube including opposing ends that are configured to mechanically interface with the longitudinal vehicle seat adjustment mechanism; and one or more mounting bodies formed on or coupled to the cross-tube; wherein the one or more mounting bodies include multiple recesses; and wherein each of the multiple recesses are configured to receive any one of multiple cross-compatible mounting arms that are included in multiple types of grab handles. In one example, attachment ends of the cross-compatible mounting arms may be identical in size and shape. In another example, the cross-tube may be an overmolded cross-tube that includes an inner metal tube and an outer plastic layer. In yet another example, the multiple recesses may include an inboard recess and an outboard recess. In another example, the one or more mounting bodies may each include an actuation lever that is configured to actuate the longitudinal vehicle seat adjustment mechanism in response to rotation of the modular base about a rotational axis of the cross-tube. In another example, the multiple types of grab handles may include a first type of grab handle that is laterally symmetric and a second type of grab handle that is laterally asymmetric. In yet another example, the first type of grab handle may include two mounting arms. In one example, each of the multiple recesses may include an upper attachment device opening and a lower attachment device opening that are configured to receive an attachment device. In another example, the multiple recesses may be identical in size and shape. In another example, each of the multiple recesses may have a polygonal cross-sectional profile.

In another aspect, a modular base for a vehicle seat actuation assembly is provided that comprises: an overmolded cross-tube including opposing ends; and a first mounting body formed on or coupled to the overmolded cross-tube; wherein the first mounting body includes a first set of recesses; and wherein the overmolded cross-tube includes an inner metal tube and an outer plastic layer. In one example, each recess in the first set of recesses may include an upper attachment device opening and a lower attachment device opening. In another example, the first mounting body may include an actuation lever. In another example, for each recess in the first set of recesses, the actuation lever may be positioned on a rear longitudinal side of the first mounting body and the first set of recesses may be positioned on a front longitudinal side of the first mounting body. In one example, the modular base may further comprise a second mounting body formed on or coupled to the overmolded cross-tube, wherein the second mounting body includes a second set of recesses. In another example, the overmolded cross-tube may include a pair of flanges formed in the outer plastic layer and positioned outboard of the first mounting body and the second mounting body.

In another aspect, an actuation assembly product line is provided that comprises: a first actuation assembly including: a first modular base including: a first cross-tube; and a first mounting body coupled to or formed on the first cross-tube and including multiple mounting arm interfaces; and a first grab handle including a mounting arm that is mated with at least one of the multiple mounting arm interfaces; and a second actuation assembly including: a second modular base including: a second cross-tube; and a second mounting body coupled to or formed on the second cross-tube and including multiple mounting arm interfaces; and a second grab handle including a mounting arm that is mated with at least one of the multiple mounting arm interfaces included in the second mounting body; wherein the first grab handle and the second grab handle have varying sizes and/or profiles; and wherein the first and second modular bases are identical in size and shape. In one example, the first grab handle may be laterally symmetric and includes two mounting arms and a grab tube that laterally extends between the two mounting arms. In another example, the second grab handle may be laterally asymmetric and includes a single mounting arm. In yet another example, the first and second grab handles may each include two mounting arms; and the first and second grab handles may have different widths.

It will be understood that the configurations disclosed herein are exemplary in nature, and that these specific embodiments are not to be considered in a limiting sense, because numerous variations are possible. For example, the above technology can be applied to a broad range of vehicles including but not limited to passenger vehicles, commercial vehicles, on and off road vehicles, light duty vehicles, medium duty vehicle, heavy duty vehicles, etc. The subject matter of the present disclosure includes all novel and non-obvious combinations and sub-combinations of the various systems and configurations, and other functions, features, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, elements, functions, and/or properties may be claimed through amendment of the present claims or through presentation of new claims in this or a related application. Such claims, whether narrower, broader, equal, or different in scope to the original claims, also are regarded as included within the present disclosure’s subject matter.

1. A vehicle seat actuation assembly for a longitudinal vehicle seat adjustment mechanism, comprising:
a modular base including:
a cross-tube including opposing ends that are configured to mechanically interface with the longitudinal vehicle seat adjustment mechanism; and
one or more mounting bodies formed on or coupled to the cross-tube;
wherein the one or more mounting bodies include multiple recesses; and
wherein each of the multiple recesses are configured to receive any one of multiple cross-compatible mounting arms that are included in multiple types of grab handles.

2. The vehicle seat actuation assembly of claim 1, wherein attachment ends of the cross-compatible mounting arms are identical in size and shape.

3. The vehicle seat actuation assembly of claim 1, wherein the cross-tube is an overmolded cross-tube that includes an inner metal tube and an outer plastic layer.

4. The vehicle seat actuation assembly of claim 1, wherein the multiple recesses include an inboard recess and an outboard recess.

5. The vehicle seat actuation assembly of claim 1, wherein the one or more mounting bodies each include an actuation lever that is configured to actuate the longitudinal vehicle seat adjustment mechanism in response to rotation of the modular base about a rotational axis of the cross-tube.

6. The vehicle seat actuation assembly of claim 1, wherein the multiple types of grab handles include a first type of grab handle that is laterally symmetric and a second type of grab handle that is laterally asymmetric.

7. The vehicle seat actuation assembly of claim 6, wherein the first type of grab handle includes two mounting arms.

8. The vehicle seat actuation assembly of claim 1, wherein each of the multiple recesses include an upper attachment device opening and a lower attachment device opening that are configured to receive an attachment device.

9. The vehicle seat actuation assembly of claim 1, wherein the multiple recesses are identical in size and shape.

10. The vehicle seat actuation assembly of claim 9, wherein each of the multiple recesses have a polygonal cross-sectional profile.

11. A modular base for a vehicle seat actuation assembly, comprising:
an overmolded cross-tube including opposing ends; and
a first mounting body formed on or coupled to the overmolded cross-tube;
wherein the first mounting body includes a first set of recesses; and
wherein the overmolded cross-tube includes an inner metal tube and an outer plastic layer.

12. The modular base of claim 11, wherein each recess in the first set of recesses includes an upper attachment device opening and a lower attachment device opening.

13. The modular base of claim 11, wherein the first mounting body includes an actuation lever.

14. The modular base of claim 13, wherein for each recess in the first set of recesses, the actuation lever is positioned on a rear longitudinal side of the first mounting body and the first set of recesses is positioned on a front longitudinal side of the first mounting body.

15. The modular base of claim 11, further comprising a second mounting body formed on or coupled to the overmolded cross-tube, wherein the second mounting body includes a second set of recesses.

16. The modular base of claim 15, wherein the overmolded cross-tube includes a pair of flanges formed in the outer plastic layer and positioned outboard of the first mounting body and the second mounting body.

17. An actuation assembly product line, comprising:
a first actuation assembly including:
a first modular base including:
a first cross-tube; and
a first mounting body formed on or coupled to the first cross-tube and including multiple mounting arm interfaces; and
a first grab handle including a mounting arm that is mated with at least one of the multiple mounting arm interfaces; and
a second actuation assembly including:
a second modular base including:
a second cross-tube; and
a second mounting body formed on or coupled to the second cross-tube and including multiple mounting arm interfaces; and
a second grab handle including a mounting arm that is mated with at least one of the multiple mounting arm interfaces included in the second mounting body;
wherein the first grab handle and the second grab handle have varying sizes and/or profiles; and
wherein the first and second modular bases are identical in size and shape.

18. The actuation assembly product line of claim 17, wherein the first grab handle is laterally symmetric and includes two mounting arms and a grab tube that laterally extends between the two mounting arms.

19. The actuation assembly product line of claim 18, wherein the second grab handle is laterally asymmetric and includes a single mounting arm.

20. The actuation assembly product line of claim 17, wherein:
the first and second grab handles each include two mounting arms; and
the first and second grab handles have different widths.
